(19) United States
(12) Patent Application Publication
(10) Pub. No.: US 2009/0266626 A1
(43) Pub. Date: Oct. 29, 2009

(54) Flexible Stylus Tip With Flat Contact Surface

(76) Inventors: Karl Robb, Fairfax, VA (US); Angela Robb, Fairfax, VA (US)

Correspondence Address: The Marbury Law Group, PLLC, 11800 SUNRISE VALLEY DRIVE, SUITE 1000, RESTON, VA, 20191, US

(21) Appl. No.: 12/423,109

(22) Filed: Apr. 14, 2009

Related U.S. Application Data
(60) Provisional application No. 61/047,802, filed on Apr. 25, 2008.

(51) Int. Cl. G06K 11/06; G06F 3/033

(52) U.S. Cl. 178/19.01; 345/179

(57) ABSTRACT

A flexible stylus tip with a flat contact surface as disclosed herein can address the problems with touch devices and prior art styli. The flexible stylus tip can be formed of resilient material and dimensioned to grip the blunt end of elongated implements such as writing utensils or fingers so as to provide for increased user comfort and control. The stylus tip is hollow and formed of flexible material such as TPV. The tip has an open end with interior gripping rings to keep the stylus tip tightly secured on a pen or other elongated implement. The tip can be slightly graduated or tapered from base to end for optimal viewing of what is being activated on the screen. The contact surface of the stylus tip is flat and larger than other stylus tips to provide an increased activation area and improved ergonomics for touch devices.

### RELATED APPLICATIONS

This application claims the benefit of U.S. Provisional Application Ser. No. 61/047,802, filed Apr. 25, 2008, which is hereby incorporated by reference for all purposes.

### BACKGROUND

The embodiments disclosed herein are drawn to flexible stylus tips that have a flat contact surface.

Traditional styli and stylus tips are rigid and have pointed or curved contact surfaces. In order to move smoothly on touch screen surfaces, the tips are made of low-friction material. In order to navigate accurately on small screen surfaces, these styli tips have small contact surfaces. Typical styli also have narrow cross sections in order to be stored integral with the device they are used with. However, such narrow styli can cause user discomfort during extended use. To avoid these issues, users have tried a pen or pencil, which is more comfortable to hold and has a larger surface area resulting in a more comfortable tool than a stick stylus, but use of writing utensils have drawbacks. Most pens will fail to grab or grip the buttons effectively. If used on a touch screen, a pen body can damage some screens and cause misalignment, a loud tapping noise, and/or give provide poor user visibility and/or feedback as to whether contact with the screen has been made. Pencil erasers will leave residue or marks on touch screens.

Currently, numerous devices such as keyboards, mini keyboards found on mobile devices, dial pads, and touch screens (collectively, “touch devices”) are designed for use with a human finger. However, such finger-operated devices can have various shortcomings. Those with physical disabilities or ailments, such as syndactyly or arthritis, can have a difficult time operating elements designed for average human fingers with average dexterity. Even users with average fingers and dexterity can have a difficult time using the small keyboards provided on devices such as mobile phones, smart phones (e.g., Treo from Palm) and Blackberries (from Research In Motion). Similarly, those with long fingernails can find that the fingernails interfere with operation of such devices.

It is also well-known that finger-operated devices that are used by the public or shared among multiple users can spread pathogens between users. The risk of such cross-contamination has increased in recent years due to the rapid adoption of public or shared touch devices and the spread of new pathogens such as Methicillin-resistant Staphylococcus aureus (MRSA).

While use of styli might prevent cross-contamination in publicly used touch devices, existing styli are ill-suited for operating keyboards, dial pads, and touch screens that have been designed for use with a human finger since they lack the contact area, flexibility, and gripping ability of fingers that are often needed for efficient operation of touch devices. Indeed, touch screens meant to be finger-operated are increasingly using technology such as surface wave, acoustic wave, infrared, resistive, and other technologies that require an activation area significantly larger than provided by a typical prior art stylus.

### BRIEF SUMMARY

Embodiments of a flexible stylus tip with a flat contact surface as disclosed herein can address the problems with touch devices and prior art styli. The flexible stylus tip can be dimensioned to grip the blunt end of elongated implements such as writing utensils or fingers so as to provide for increased user comfort and control.

For touch screens, the flexible stylus tip with a flat surface area can be used with or without a writing instrument so as to prevent finger contact with the screen. In use, embodiments provide tactile feedback with the screen, provide sufficient activation area for proper operation of the screen, keep the screen clean, keep the users' hands clean, and protect the surface of the screen from scratches.

For touch devices such as cell phones and Blackberries, embodiments of a flexible stylus tip with a flat contact surface as disclosed below can provide a suitable material, shape, and size to conform and grab the protruding mini keyboard buttons, allowing for a firm hold to depress the button securely. In certain embodiments, the flexible stylus tip with a flat surface transforms most pens and pencils into an effective stylus for many touch devices. The flexibility and flat surface of the stylus tip provides surface tension with small buttons but has a good pressure feel against a touch screen. The stylus tip is hollow and formed of flexible material such as Sanoprene®. The tip has an open end with interior gripping rings to keep the stylus tip tightly secured on a pen or other elongated implement. The tip can be slightly graduated or tapered from base to end for optimal viewing of what is being activated on the screen. The contact surface of the stylus tip is flat and larger than other stylus tips to provide an increased activation area to the screen. This larger, flat contact surface can thus activate some screens that require a larger activation point than prior art styli are capable of producing.

Embodiments of the stylus tip can provide an inexpensive solution to turning almost any standard writing instrument or similar device into a stylus to be used on touch screens and small buttons. The flexible stylus tip and flat contact surface speeds up and improves accuracy of data entry on touch devices, keeps touch devices free of scratches, smears, oily finger residue, other finger residue (dirt, food, germs, etc.), and stray touches (since the stand-off provided by an elongated instrument prevents other fingers or knuckles from inadvertently touching the screen). Embodiments can be designed or customized to be the ideal size and shape to activate touch screens requiring a specific amount of surface area to be contacted for activation (note: this might also be used to prevent a user from using any other object for screen activation in order to protect the screen from damage or residue). Embodiments can also improve users control and manipulation of protruding buttons and keys, like those on many cell/smart phones and Blackberries.

### BRIEF DESCRIPTION OF THE DRAWINGS

FIG. 1 illustrates a cross section of an embodiment of a flexible stylus tip;

FIG. 2A illustrates a view of a second embodiment of a flexible stylus tip;

FIG. 2B illustrates a cross section view the embodiment of FIG. 2A; and

FIG. 3 illustrates an embodiment of a stylus formed with a flexible stylus tip.

### DETAILED DESCRIPTION

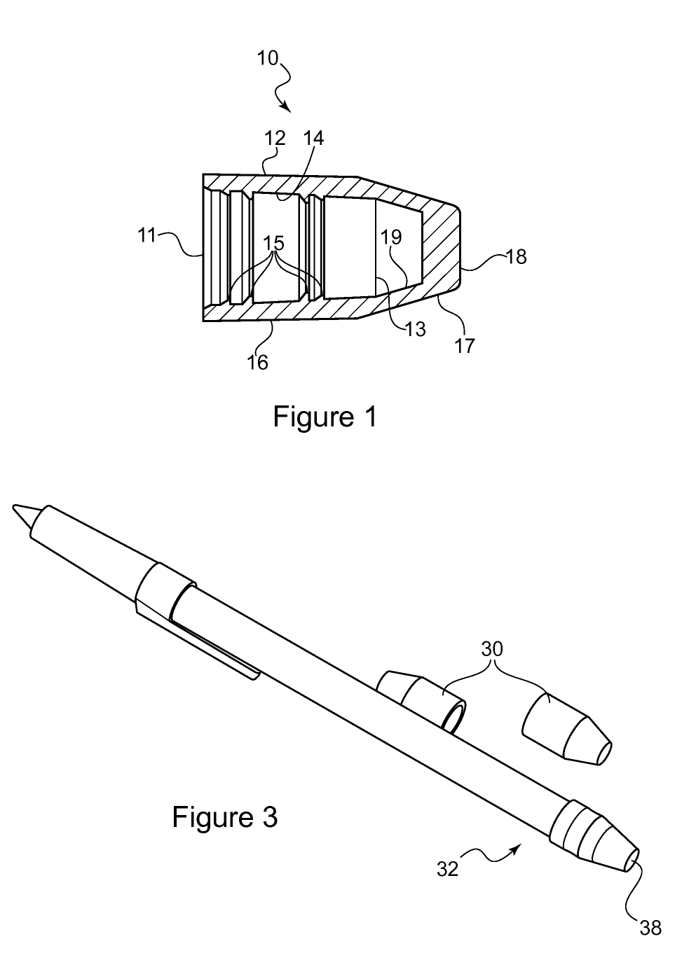

One embodiment of a flexible stylus tip with a flat contact surface is disclosed in FIG. 1, which illustrates a cross section of a stylus tip 10. Stylus tip 10 comprises a substantially cylindrical body 12 that has an open end 11 at a first end and a tapered tip portion 17 extending from a second end. The open end 11 of the stylus tip 10 is dimensioned for use with an elongated implement. In an exemplary embodiment for gripping a pen, open end 11 has an approximate 0.305″ diameter opening that tapers to approximately 0.26″ at the second end of body 12. This narrowing of the inside wall on the body 12 of the stylus tip 10 provides additional gripping of an implement based upon increased insertion. An inside wall 14 of the body 12 also includes a plurality of gripping rings 15. The disclosed gripping rings 15 in this embodiment have cross sections formed substantially as right triangles with the right angle facing away from the open end 11, thus allowing easier insertion than extraction. As such, the body 12 of the stylus tip 10 provides a gripping function to allow the device to be used with an elongated implement such as a writing utensil. An outer wall 16 of body 12 can also be gripped manually to provide a very short stylus to a user.

A tip portion 17 of the stylus tip 10 tapers to a flat contact surface 18. While many forms can be used to taper the tip portion 17, a frusti-conical shape with a cone angle between approximately 40 and 50 degrees allows for a shape that provides good visibility of the tip portion 17 when in use. The wall thickness at the contact surface 18 is preferably greater to provide a relative amount of stiffness, which allows pressure to flex tapered sidewalls 19 of the tip portion 17 and thereby maintain desirable contact of the flat contact surface 18 with a device being operated. Additionally, the depth and flexibility of the flat contact surface 18 provides an ability to securely contact small buttons.

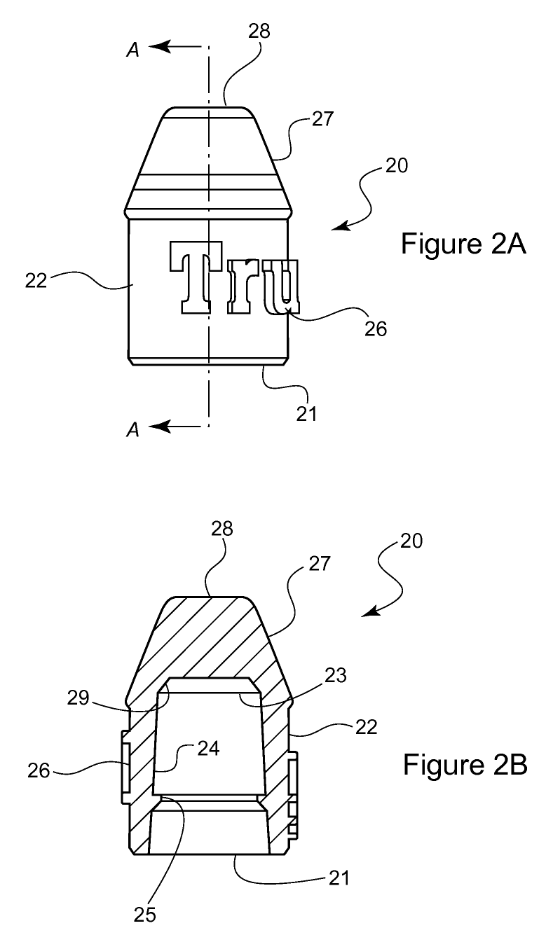

FIGS. 2A-2B illustrate another embodiment of a flexible stylus tip 20 with a flat contact surface 28, in which a brand-name is molded into an outer wall 26 of the body 22 of the stylus tip 20. The molded brand-name provides marketing for the brand while adding additional surface area for improved gripping and handling of the flexible stylus tip 20.

Again, as seen in FIG. 2B, an object inserted into the open end 21 will meet resistance from increasingly narrow portions of the sidewalls of the body 22 and a gripping ring 25 on interior wall 24.

As illustrated in FIGS. 2A-2B, the tapering of the tip portion 27 does not have to be a single conic frustrom, but can be done with a series of frustroms. The tapering provides for good visibility of the location of the flat surface 28 of the tip portion 27 and makes a smooth transition from the large diameter of body 22 needed for gripping typical writing utensils to the generally smaller diameter of flat surface 28 needed for accurate pointing and activation of touch devices.

Preferably, the wall thickness at the contact surface 28 is greater than the wall thickness of tapered sidewalls 29 to provide a relative amount of stiffness, which allows pressure to flex tapered sidewalls 29 of the tip portion 27 and thereby maintain desirable contact of the flat contact surface 28 with a device being operated.

As illustrated in FIG. 2B, a gripping ring 25 is inwardly angled from interior wall 24 so as to ease insertion of an implement, but to resist withdrawal of the implement so as to improve the ability of the flexible stylus tip 20 to grip the implement. In an exemplary embodiment, a flexible stylus tip 20 with a flat contact surface 28 is formed by molding it from Sanoprene brand TPV (thermoplastic vulcanizates). Suitable materials include soft, malleable materials that will stretch and retract but not rip or break. The surface of suitable materials should also have a moderate coefficient of friction so as to provide feedback and securely contact touch devices. Unlike pencil erasers, the material should not leave a residue or marks on touch screens.

While the disclosed flexible stylus tips 10 and 20 can be used alone by gripping the body 12, 22, they will typically be used by stretching the body 12, 22 over the blunt end of a pencil, pen or pencap (i.e., inserting the pencil, pen or pencap into the open end 11, 21 of the flexible stylus tip 10, 20) to form a stylus out of the pencil or pen, as illustrated in FIG. 3. The resulting stylus 32 includes the flat contact surface 38 and has many uses, including but not limited to:
activating buttons on a Blackberry or cellphone by gripping the buttons;
operating a touch screen to activate small buttons within software;
increasing pointing accuracy with touch screens;
keeping touch screens cleaner;
reducing touch screen damage (scratches, punctures, etc) caused by using foreign objects on the screen;
keeping touch screens calibrated;
activating surface wave, infrared, sound wave, and resistive touch screens;
reducing wear and tear on touch screen and other touch devices;
providing an economical replacement stylus solution;
providing a good stylus for activation of calculator buttons;
providing an assistive stylus device for those with physical challenges;
providing a page turning device for those with physical challenges;
activating touch screens on GPS units;
activating restaurant/retailers Point of Sale touch screen systems;
activating touch devices used by those with physical and cognitive challenges;
providing tactile feedback to touch screen users; and
preventing the spread of pathogens via publicly-used or shared-user touch devices.

As illustrated in FIG. 3, embodiments of the flexible stylus tip 30 can be small so as to take up little storage space. Numerous such flexible stylus tips 30 can be carried in a pocket for personal use and sharing with others.

In one embodiment, a flexible stylus tip comprises a hollow, substantially cylindrical body formed of flexible material, the body having an open first end dimensioned for stretching over and gripping an elongated implement, and a hollow tip formed of flexible material, the tip extending from a second end of the body and tapering from an outer diameter of the body to a flat contact surface that is substantially circular with an effective diameter between 5 mm and 6 mm. The open end of the body is preferably sized for gripping an elongated implement, such as pen bodies, pen tips, marker bodies, marker tips, pencils, dowels, and styli. A variation can include a tip that is frusto-conical so as to improve the visibility of the activation area of the flat surface to a user. In this embodiment, the flat contact surface is preferably substantially perpendicular to an axis of the body.

To assist in retaining this embodiment on an elongated implement, an internal surface of the body preferably includes a raised gripping surface such as a ring of flexible material. Retention can also be assisted by forming the hollow, substantially cylindrical body as a conic frustum with an opening angle of approximately 6 degrees. In this manner, increased insertion results in a tighter fit.

The flexible material for this embodiment is preferably selected from a group consisting of thermoplastic, thermoplastic vulcanizate (such as Sanoprene-brand TPV), thermoplastic olefin, polyvinyl, rubber, vinyl, plastic, polymer, and high density polyethylene. Additionally, the flat contact surface preferably has a wall thickness greater than a wall thickness of the body so as to provide a relative amount of stiffness, which allows pressure to flex tapered sidewalls of the tip portion and thereby maintain desirable contact of the flat contact surface with a device being operated.

In a second embodiment, the flexible stylus tip again comprises a hollow, substantially cylindrical body formed of flexible material. In this embodiment, the body further comprises an open first end with an inner diameter of approximately 7.75 mm for stretching over and gripping an elongated implement, a body wall with a thickness of approximately 1.08 mm and an axial length of approximately 10-12 mm, a second end with an inner diameter of approximately 6.6 mm, and a plurality of gripping rings extending from an internal surface of the body wall. The body also comprises a hollow frusto-conical tip formed of flexible material, the tip extending approximately 20 mm to 30 mm from a second end of the body and tapering to a flat contact surface that is substantially perpendicular to an axis of the body, the contact surface being substantially circular with an effective diameter of approximately 5.3 mm. Preferably, the flat contact surface has a wall thickness greater than a wall thickness of the body.

The gripping rings preferably have substantially triangular cross sections, and, in an embodiment, the substantially triangular cross sections of the gripping rings are right triangles with a right angle on a side closest to the frusto-conical tip. In one variation of this second embodiment, the gripping rings comprise a first ring extending approximately 0.254 mm, a second ring extending approximately 0.508 mm, a third ring extending approximately 0.508 mm, and a fourth ring extending approximately 0.254 mm.

Variations of the second embodiment include those wherein the flexible material is selected from a group consisting of thermoplastic, thermoplastic vulcanizate, thermoplastic olefin, polyvinyl, rubber, vinyl, plastic, polymer, and high density polyethylene. Other variations of the second embodiment include those wherein the flexible material is thermoplastic vulcanizate and the flat contact surface has a wall thickness of approximately 2.54 mm, and those wherein the elongated implement is selected from the group consisting of pen bodies, pen tips, marker bodies, marker tips, pencils, dowels, and styli.

In a third embodiment, the flexible stylus tip comprises a hollow, substantially cylindrical body formed of flexible material, the body further comprising an open first end with for stretching over and gripping an elongated implement, a body wall extending axially from the open first end, a second end, and a gripping ring extending from an internal surface of the body wall. The stylus tip further comprises a substantially frusto-conical tip formed of flexible material, the tip extending from a second end of the body and tapering to a flat contact surface that is substantially perpendicular to an axis of the body, the contact surface being substantially circular with an effective diameter of approximately 4.2 mm to 6.1 mm.

In one variation of the third embodiment the flat contact surface has a wall thickness greater than a wall thickness of the body. In another variation, the gripping ring has a substantially triangular cross section. In yet another variation, the flexible material is selected from a group consisting of thermoplastic, thermoplastic vulcanizate, thermoplastic olefin, polyvinyl, rubber, vinyl, plastic, polymer, and high density polyethylene. In an exemplary embodiment, the flexible material is thermoplastic vulcanizate such as Sanoprene and the flat contact surface has a wall thickness of approximately 5.3 mm.

Other variations of the third embodiment include those wherein the elongated implement is selected from the group consisting of pen bodies, pen tips, marker bodies, marker tips, pencils, dowels, and styli, those wherein interior walls of the body wall flare towards the open first end at an approximately 3 degree angle from a central axis, and those wherein a cone angle of the frusto-conical tip is approximately 47 degrees.

A flexible stylus tip with a flat surface has been described. It will be understood by those skilled in the art that the present invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible. Further, any reference to claim elements in the singular, for example, using the articles “a,” “an,” or “the” is not to be construed as limiting the element to the singular.

What is claimed is:

1. A flexible stylus tip, comprising:
a hollow, substantially cylindrical body formed of flexible material, the body having an open first end dimensioned for stretching over and gripping an elongated implement; and
a hollow tip formed of flexible material, the tip extending from a second end of the body and tapering from an outer diameter of the body to a flat contact surface that is substantially circular with an effective diameter between 5 mm and 6 mm.

2. The flexible stylus tip of claim 1, wherein the tip is frusto-conical.

3. The flexible stylus tip of claim 1, wherein the flat contact surface is substantially perpendicular to an axis of the body.

4. The flexible stylus tip of claim 1, wherein an internal surface of the body includes a raised gripping surface.

5. The flexible stylus tip of claim 5, wherein the raised gripping surface comprises a ring of flexible material.

6. The flexible stylus tip of claim 1, wherein the hollow, substantially cylindrical body is a conic frustum with an opening angle of approximately 6 degrees.

7. The flexible stylus tip of claim 1, wherein the flexible material is selected from a group consisting of thermoplastic, thermoplastic vulcanizate, thermoplastic olefin, polyvinyl, rubber, vinyl, plastic, polymer, and high density polyethylene.

8. The flexible stylus tip of claim 1, wherein the flat contact surface has a wall thickness greater than a wall thickness of the body.

9. A flexible stylus tip, comprising:
a hollow, substantially cylindrical body formed of flexible material, the body further comprising:
an open first end with an inner diameter of approximately 7.75 mm for stretching over and gripping an elongated implement,
a body wall with a thickness of approximately 1.08 mm and an axial length of approximately 10-12 mm,
a second end with an inner diameter of approximately 6.6 mm, and
a plurality of gripping rings extending from an internal surface of the body wall; and
a hollow frusto-conical tip formed of flexible material, the tip extending approximately 20 mm to 30 mm from a second end of the body and tapering to a flat contact surface that is substantially perpendicular to an axis of the body, the contact surface being substantially circular with an effective diameter of approximately 5.3 mm.

10. The flexible stylus tip of claim 9, wherein the flat contact surface has a wall thickness greater than a wall thickness of the body.

11. The flexible stylus tip of claim 9, wherein the gripping rings have substantially triangular cross sections.

12. The flexible stylus tip of claim 11, wherein the substantially triangular cross sections of the gripping rings are right triangles with a right angle on a side closest to the frusto-conical tip.

13. The flexible stylus tip of claim 9, wherein the flexible material is selected from a group consisting of thermoplastic, thermoplastic vulcanizate, thermoplastic olefin, polyvinyl, rubber, vinyl, plastic, polymer, and high density polyethylene.

14. The flexible stylus tip of claim 9, wherein the flexible material is thermoplastic vulcanizate and the flat contact surface has a wall thickness of approximately 2.54 mm.

15. A flexible stylus tip, comprising:
a hollow, substantially cylindrical body formed of flexible material, the body further comprising:
an open first end dimensioned for stretching over and gripping an elongated implement,
a body wall extending axially from the open first end,
a second end, and
a gripping ring extending from an internal surface of the body wall; and
a substantially frusto-conical tip formed of flexible material, the tip extending from a second end of the body and tapering to a flat contact surface that is substantially perpendicular to an axis of the body, the contact surface being substantially circular with an effective diameter of approximately 4.2 mm to 6.1 mm.

16. The flexible stylus tip of claim 15, wherein the flat contact surface has a wall thickness greater than a wall thickness of the body.

17. The flexible stylus tip of claim 15, wherein the gripping ring has a substantially triangular cross section.

18. The flexible stylus tip of claim 15, wherein the flexible material is selected from a group consisting of thermoplastic, thermoplastic vulcanizate, thermoplastic olefin, polyvinyl, rubber, vinyl, plastic, polymer, and high density polyethylene.

19. The flexible stylus tip of claim 15, wherein the flexible material is thermoplastic vulcanizate and the flat contact surface has a wall thickness of approximately 5.3 mm.

20. The flexible stylus tip of claim 15, wherein:
the interior surface of the body walls flare towards the open first end at an approximately 3 degree angle from a central axis; and
the frusto-conical tip has a cone angle of approximately 47 degrees.
